(19) United States
(12) Patent Application Publication
(10) Pub. No.: US 2002/0052934 A1
(43) Pub. Date: May 2, 2002

(54) Personalized agent for website direction

(76) Inventor: Michael Emmett Doherty, Cincinnati, OH (US)

Correspondence Address: Michael Emmett Doherty, 5542 Squirrel Run Ln., Cincinnati, OH, 45247, US

(21) Appl. No.: 09/939,924

(22) Filed: Aug. 27, 2001

Related U.S. Application Data
(60) Provisional application No. 60/228,168, filed on Aug. 28, 2000.

(51) Int. Cl. G06F 15/16

(52) U.S. Cl. 709/219; 709/218

(57) ABSTRACT

An apparatus, program product, and method provide personalized assistance to a user navigating locations on a hyperlinked network, such as websites on the public internet or a private intranet. The system enabling this method is comprised of two websites: an Agent Link Creation Website and an Agent Website. The first one creates a customized Agent Link which points to the second one. Using a web browser, the user saves the customized Agent Link, for example on a menu bar or in a bookmark list, and later uses it whenever desired. The Agent Link transfers the user's web browser to the Agent Website and delivers two key types of information: the link address of the web page the user was viewing, and a set of information personalized to the user. The Agent Website uses that information and may present the user relevant information of potential interest, possibly including where to go next. Alternatively it may automatically transfer the user to a different location.

### CROSS-REFERENCE TO RELATED APPLICATION

This application is entitled to the benefit of Provisional Patent Application (Ser. No. 60/228,168), titled “Personalized Agent for Website Direction,” filed Aug 28, 2000 by Michael Emmett Doherty, Cincinnati, Ohio, inventor.

### FIELD OF THE INVENTION

The invention is generally related to marketing and market research through electronic media. More particularly, the invention is related to automated assistance to persons navigating a hyperlinked network.

### BACKGROUND OF THE INVENTION

Television provided a medium in which the control of what came next was in the hands of the networks, producers, and advertisers. The viewer had control over switching channels, turning the volume down, or averting attention. A dramatic reversal has occurred for persons who are viewing content on a hyperlinked network, such as the World Wide Web. In this situation the viewer is quite likely to be continually “switching channels” by clicking on links to other web pages.

Marketers would naturally like to be able to sometimes intervene and tell the viewer messages like “don't buy that item at that website, come over to mine and get a better deal” or “I have a product superior to the one you're looking at.” But the user is in control, not the marketer.

Market researchers would naturally like to be able to sometimes intervene and ask the viewer questions like “why do you find this information useful?” or “what would you consider a fair price for this product?”.

We will sometimes refer to the marketers, market researchers, or others with an interest in intervening the viewer's activity as the “business” or alternatively the “enterprise.” We will sometimes refer to the viewer as the “user.”

Broadly there are two major methods to enable interventions like those described. One is by running monitoring software on the viewer's computer, that continually watches which web pages are being viewed. It can then match them, as each is visited, against a list of interest and trigger a forced interruption. The other method is sometimes called the “opt-in” design, whereby the intervention is triggered only when the user freely chooses to allow it, perhaps by clicking on something on the computer screen.

The continual monitor method has several disadvantages. Although it can be effective for the business, it requires that the user relinquish control over what happens next. This can lead to annoying interruption. It also requires that the software have access to a list of web addresses where an interruption should be triggered. Only in limited or trivial cases would this list be small and unchanging. Hence the monitor must either refresh a potentially large list kept locally, or constantly communicate to a remote list. This processing can impair the performance the user experiences while navigating, and may even double the amount of work the web browser has to perform. In addition, because the monitor has the ability to watch wherever the user navigates, the user's privacy may be compromised. An example of this continual monitor method was provided by TopMoxie (www.topmoxie.com).

The opt-in method has disadvantages, but not those described for the continual monitor. One disadvantage is that it may be forgotten or ignored by the user at a time when it would be advantageous to the business. Another disadvantage is that it may be forgotten or ignored when it would be advantageous to the user. Also, the opt-in method needs “a place” where the triggering mechanism can be activated by the viewer who opts. Among possible alternatives, this might be a button or link on the web browser, or a bookmark saved in a list. This is unlike the continual monitor which may run, invisibly, in the background. An example of the opt-in method was provided by Dash (www.dash.com), which has terminated it service.

A significant need therefore exists in the art for a manner of providing opt-in assistance to a user navigating a hyperlinked network, wherein the user is provided a motivation to opt-in.

### SUMMARY OF THE INVENTION

The invention addresses these and other problems associated with the prior art by providing an apparatus, program product, and method that analyze the link address of a web page the user is viewing, along with information personalized to the user, and produce an intervention. This intervention may be tailored to the user's interest by using the personalized information, and hence provide more motivation for the user to opt-in than a method which is insensitive to information about the user. As will be explained in examples below, the personalization data may include among other items: account codes so shopping rebates can be credited, political interests, age, or hobbies.

The invention collects information personalized to the user and combines it with a small program script, producing a customized link which is presented to the user. Along with the presentation the user may receive instruction on how to save the link and use it later, and other relevant information. When the use opts-in and activates the saved link, the program script is activated. This script retrieves the link address of the web page the user is viewing and transfers the browser to another website, the Agent Website, communicating the link address retrieved and the personalized information. At the Agent Website this communicated data is analyzed, possibly using algorithms and databases, and produces information to display to the user as the intervention. This intervention may be a suggestion for an alternative website to visit. The intervention may be a caution, warning, or endorsement or the website that was being viewed. The intervention may be additional information relevant to the user and the viewed site, or it may be a question or survey presented to the user.

The advantages and features, which characterize the invention, are set forth in the claims annexed hereto and forming further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of an apparatus providing personalized assistance to a user navigating a hyperlinked network, consistent with the invention.

FIG. 2 is a depiction of an example message from the Agent Link Creation Website to the user, in the operation of the apparatus of FIG. 1.

FIG. 3 is a depiction of an example web browser configuration, showing the Agent Device, in the operation of the apparatus of FIG. 1.

FIG. 4 is a depiction of an example message from the Agent Website to the user, in the operation of the apparatus of FIG. 1.

### DETAILED DESCRIPTION

The embodiments described herein provide website direction to a user navigating a hyperlinked network. In general, website direction consistent with the invention may be utilized in connection with the World Wide Web of the public internet, intranets such a corporation's internal web, or other hyperlinked networks. Hyperlinked networks are comprised of any content, such as electronic text, pictures, audio, video or other information, which is connected to other content by means of address links which permit a user to jump from one content to another by using a tool such as a browser. Examples of browsers for the World Wide Web include Microsoft's Internet Explorer and Netscape's Navigator. Devices such as cellular phones, personal digital assistants, and WebTV may employ alternate methods for a user to browse and jump from one content area to another.

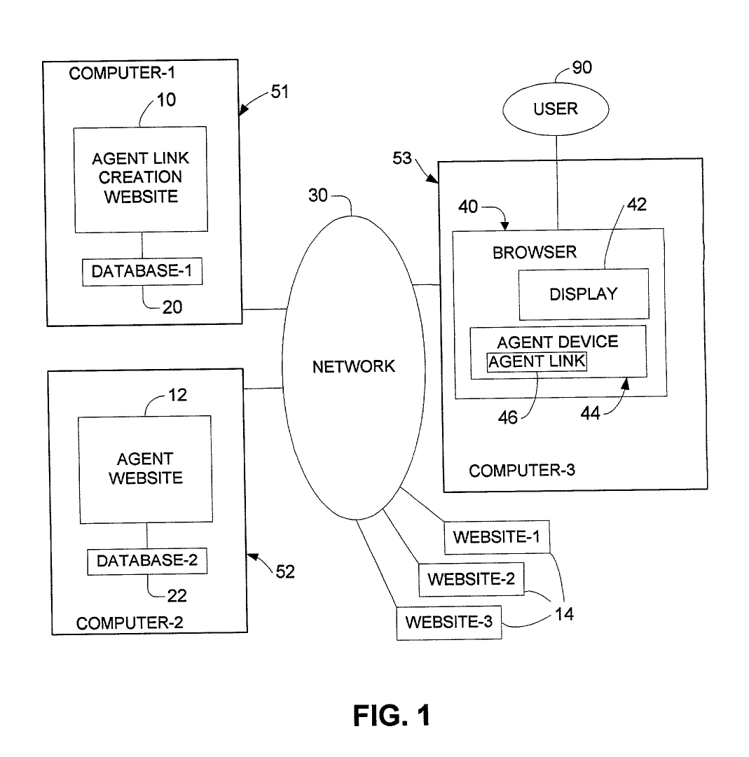

Turning now to the Drawings, wherein like numbers denote like parts throughout the several views, FIG. 1 illustrates an exemplary application of the provision of personalized assistance to user 90 navigating hyperlinked network 30. User 90 employs browser 40 which presents information to the user via display 42. Browser 40 has agent link device 44 which, when activated by the user, directs the browser to the network address designated by agent link 46. Agent Link Creation Website 10 creates Agent Link 46, which points to Agent Website 12. Websites 14 are also locations on network 30, such as web merchants and news sites, which the user may visit from time to time.

### Method

The following steps provide a detailed description of the method.

Step 1. The business creates Agent Link Creation Website 10 of FIG. 1 and corresponding Agent Website 12 of FIG. 1. In addition, the business may create Database 20 and connect it to Agent Link Creation Website 10. Also, the business may create Database 22 and connect it to Agent Website 12.

Step 2. The business invites user 90 to Agent Link Creation Website 10 by providing the user the web address (Universal Resource Locator, or URL) to it. This invitation may be communicated by electronic mail or other means, and may include other information, such as how it will work and/or why it may be beneficial.

Step 3. Using web browser 40, user 90 goes to Agent Link Creation Website 10. That website gathers personalization information, by using one or more of the following methods:

a) the user choosing one or more preferences, from offered sets. (e.g. [male, female], [Republican, Democrat, Independent])

b) the user expressing free form personalized information (e.g. “Yankees”)

c) a query string in the URL to the Agent Link Creation Website (e.g. “?user_id=88312”)

Alternatives presented to the user and/or the resultant personalization data may be stored in and retrieved from Database 20.

Step 4. Agent Link 46 URL is created, containing codes corresponding to the user's personalization information. This URL points to Agent Website 12 and contains instructions in a language such as JavaScript. Those instructions, when activated, detect the URL of the then-current web page of browser 40, and package that information with the personalization information and communicate it to Agent Website 12.

Step 5. The user is instructed to create Agent Device 44 on browser 40. For example the user may click and drag the Agent Link 46 URL shown on the page onto a Links menu bar. Or the user may right mouse click on the URL of Agent Link 46 and add it to his or her bookmarks. Or the user may click on an icon that creates a menu bar with a button or adds a button to an existing menu bar. (The details of which methods are possible, appropriate, or preferred may depend on the specific browser being used by the user. Details of this are shown in the embodiment of Example 4 below, in Table 1.) In any case, what is created is a web link with embedded instructions and data, that can be easily and conveniently activated by the user, at any subsequent time while browsing pages on the web. The Agent Link device is labeled automatically or by the user to reflect the personalization data, e.g. “Mike's”.

Step 6. The user may opt to create additional Agent Devices with various sets of personalization data.

Step 7. While browsing the web, at a web page (also called a network location, with examples indicated as websites 14) hereinafter referred to as the subject page, the user at any time desired chooses to click on Agent Device 44 (bookmark, menu item, button, or other mechanism). The instructions in Agent Link 46 URL are activated, capture the web address of the subject page, and send this data, along with the personalization data codes, to Agent Web Site 12. There reference data, possibly retrieved from database 22, is used to perform the following analysis. The personalization data and web address are checked for matches in reference data. The result can be one or more pieces or data such as text, images, sounds, animations, videos, or web links. At this point data may optionally be recorded in a storage area, which may be database 22, specifying the personalization data and web address, and date and time it was sent by the user's Agent Device. If no matches are found, then the user's browser is redirected to the subject page; optionally a message may be presented before doing this.

If a match is found then, by choice of the business's system designer, any of the following can occur using the data produced in the match:

a) the user is automatically switched to another website

b) the user is presented additional media which may be about the subject page, and may be customized to interests corresponding to the personalization data

c) the user is asked for input (subjective or objective) about the subject page

d) the user is given a set of one or more web pages to navigate to

### EXAMPLES

In order to further explain the invention the following examples of use are presented. These example do not represent all the capabilities of the invention, and restrictions they may convey may be incidental.

### Example 1

The personalization data represents a special interest group. The user picks “Greenpeace”. A menu bar link is created and labeled “Gpeace”. While at WhalersCo business website, the user clicks the Gpeace link. A database check produces a match and the user gets a text message “This company violates Greenpeace principles for earth-friendly operations. Do not patronize it! Click here to send a complaint letter to the CEO.”

### Example 2

The personalization data represents a demographic attribute. The user specifies “female, 30-40 yrs. old.” A bookmark is created and labeled “MomsVote”. While at Borders website, the user clicks the bookmark- She is asked to take a brief survey about that website (e.g. is it attractive?, does she shop there?, how often does she go there?). She may be offered incentive for providing the survey data.

### Example 3

The personalization data represents a filter. The user, a parent, specifies “PG-13”. She discovers that her child has visited the DarkSecrets website. The parent herself goes to the DarkSecrets website, and clicks on the Agent Link. A message is returned saying “the site is not approved for viewers 13 or younger.” The parent may then know that her child has been in forbidden areas.

### Example 4

### Implementation Consistent with this Example is Detailed Below in the System Enablement Discussion

(This example applies to e-businesses that provide shopping links or shopping portals and collect rebates for referring shoppers to web merchants who participate as affiliates. Examples include www.scholarshops.com and www.schoolpop.com.)

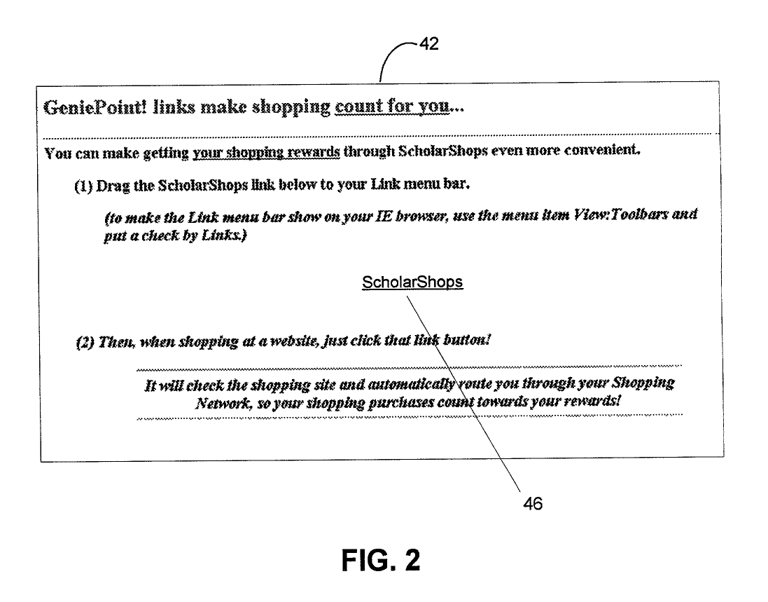

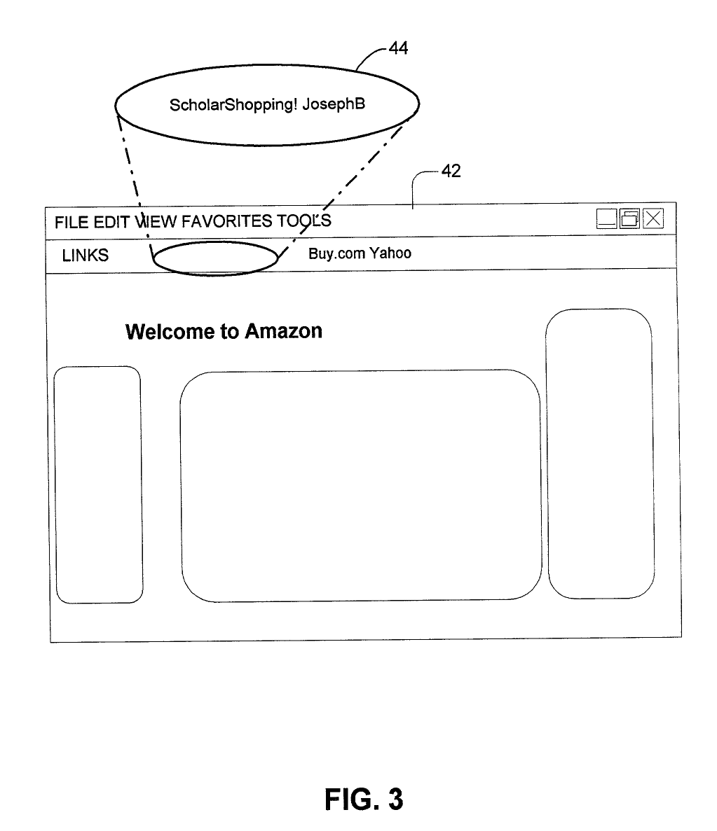

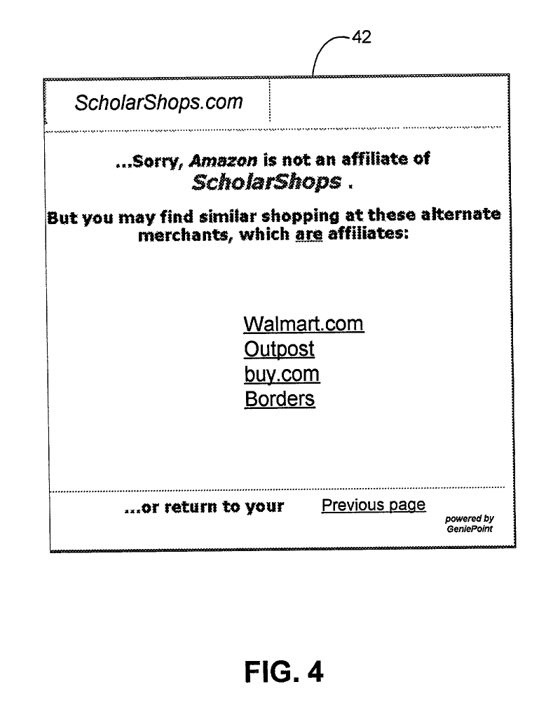

Among the Drawings, FIG. 2, FIG. 3, and FIG. 4 provide supporting explanation of this example.

The personalization data represents a shopping network and a person's account at that network.

The user, Frank, has a nephew, Joe Black. Joe is a college student and is enrolled in a shopping network program named ScholarShops, in which he has a rebate account. That account gets cash credits when web purchases are made at merchants who are affiliates of ScholarShops. However, when the shopping occurs, the web link to the merchant must have Joe's account code in it for him to get the credit.

The nephew e-mails his uncle Frank a message, appealing for support. The e-mail message has a link to the Agent Link Creation Website; and the link includes Joe's account ID code at Scholarshops, as well as the ID code for Scholarshops as a shopping network. (Table 4 in subsequent exposition shows this message.) The uncle gets the message, follows the link. FIG. 2 shows the message which he sees in display 42 of his browser. The message contains Agent Link 46. Following the instructions in the message, Uncle Frank drags and creates a Link menu item, and labeles it “ScholarShopping JosephB”. This is Agent Device 44 of Browser 42, shown in FIG. 3.

While at the Hallmark website, Joe's uncle Frank is about to make an online purchase, but remembers Joe. He clicks the Agent link, which uses the personalization data (Joe's account ID and Scholarshops' ID) and the website location, does a database lookup and creates the full URL to Hallmark, with rebate codes for Joe's account in them. It immediately transfers him back to the Hallmark site with that URL. When he now proceeds with a purchase, Joe will be the beneficiary, obtaining the rebates.

On another occasion Joe's uncle Frank is shopping at Amazon and clicks Agent link 44 (refer again to FIG. 3). This time he gets a message on his browser's display 42, shown in FIG. 4, which states that Amazon is not an affiliate in the rebate program that Joe is enrolled in, but points out that Borders and others are affiliate, and suggests shopping there instead (and provides a link to click). Uncle Frank clicks the link for Borders and is transferred to Borders website with a URL that has the account code for Joe in it. Now his shopping at Borders will generate rebates for Joe.

The enterprise that produced the Agent Website may control the list of merchant substitutions, and strategize to charge Borders for being the suggested alternative to Amazon. The enterprise may use the traffic data from users and their redirection patterns to persuade Amazon to become an affiliate merchant, so that users don't balk and shop elsewhere to ensure a rebate.

### System Enablement

The following presents how the method described above can be implemented into a working system. This description shows how to apply the method of the invention to a particular hyperlinked network, the World Wide Web. A person ordinarily skilled in the art of website development, including Active Server Pages, JavaScript, and database methods, could produce a working version of the invention using the disclosure of this patent application. Typical software tools that may be employed include, but are not restricted to: Microsoft Front Page, Microsoft Access, Microsoft Internet Information Server, Microsoft Internet Explorer.

Software Environment

(1.) The Agent Link Creation Website can be implemented using Active Server Pages. The personalized information may be obtained from query string arguments or from form elements (such as radio buttons, text boxes, or pull-down lists) on the web page. For example, If the personalized information items have values data1, data2, and data3, then a text string of the form:

info 1=data1&info2=data2&info3=data3

is created. This is combined with fixed text elements to produce the Agent Link URL:

javascript:self.location=“http://www.agent.com/home.asp?info1=data1&
info2=data2&info3=data3&frompage=”+escape(document.URL);void(0);

where

www.agent.com is the Agent Website.

home.asp is an active server page at the Agent Website.

escape(document.URL) is program script which captures the URL of the website the user is browsing at the time the Agent Link is clicked.

?info1=data1&info2=data2&info3=data3&frompage=″+escape(document.URL) is a query string, which is communicated to the home.asp page when the user clicks.

(2.) The Agent Website can be implemented using Active server Pages. A home page, home.asp, accepts the query string in the Agent Link URL and from it extracts the values data1, data2, and data3, and the URL that was browsed. It then can use those values, and optionally compute derived values, and optionally construct an SQL query to a database.

Tables 1, 2, and 3 provide exemplary implementations, using Active Server Pages, consistent with Example 4 discussed above. In this exemplary implementation an enterprise has created a website named GeniePoint, and registered it on the World Wide Web at http://www.geniepoint.com.

Table 1 shows an exemplary implementation of Agent Link Creation Website 10 page. It's name is linkgen. asp, and its full address is http://www.geniepoint.com/geniepoint/linkgen.asp.

TABLE 1
Exemplary ASP code for
Agent Link Creation website

```
<%Response.Buffer = true%>
<html>
<head>
<meta http-equiv=“Content-Language” content=“en-us”>
<meta http-equiv=“Content-Type” content=“text/html; charset=windows-1252”>
<meta name=“GENERATOR” content=“Microsoft FrontPage 4.0”>
<meta name=“ProgId” content=“FrontPage.Editor.Document”>
<title>GeniePoint! </title>
</head>
<body>
<p><b><font color=“#800080” size=“5”>GeniePoint! links make shopping
<u>count for
you</u>. . .</font></b></p>
<%set sn_id = Request.QueryString(“sid”)%>
<%set acct_id = Request.QueryString(“aid”)%>
<%
Response.Expires=0
Dim Var
Set Var=Request.ServerVariables
browser=“other”
Dim ua
ua=Var(“HTTP_USER_AGENT”)
if Instr(ua, “MSIE”) then
  browser=“IE”
End if
if Instr(ua, “Mozilla”) and Instr(ua, “compatible”)=0  then
  browser=“Netscape”
End if
if Instr(ua, “AOL”) then
  browser=“AOL”
End if
%>
<%Set MyConnection = Server.CreateObject(“ADODB.Connection”)
MyConnection.Open “Provider=Microsoft.Jet.OLEDB.4.0;Data
Source=d:\inetpub\065\_private\Data\genie.mdb”%>
<%Query1 = “SELECT * FROM ShoppingNetwork WHERE ShoppingNetworkID = ” &
sn_id & “ ”%>
<%Set List1 = MyConnection.Execute(Query1)%>
<hr>
<% If List1.EOF then
  Response.Write(“id not found in database”)
  End if%>
<% If Not List1.EOF then %>
<%set NetworkName = List1 (“ShoppingNetworkName”)
  End if%>
<%randomize()%>
<%
n=now()
yy=Year(n) -2000
mm=Month(n)
dd=Day(n)
dig=5
r=int((10\hat{ }dig)*rnd())
gpid=r+(10\hat{ }dig)*(dd+100*(mm+100*yy))
Response.Write(code)
%>
<%datestamp=now()%>
<%Const adOpenDynamic = 3, adLockOptomistic = 3%>
<%Set MyConnection2 = Server.CreateObject(“ADODB.Connection”)%>
<%MyConnection2.Open “Provider=Microsoft.Jet.OLEDB.4.0;Data
Source=d:\inetpub\065\_private\Data\Data2\gptracking.mdb”%>
<%Query2 = “INSERT INTO Users (gpuser_id) VALUES (“ & gpid & ”)”%>
<%Query2 = “INSERT INTO Users (date_time,gpuser_id) VALUES (“““ & datestamp
& ”””,“ & gpid & ”)”%>
<%MyConnection2.Execute(Query2)%>
<b><font size=“4”>
You can make getting <u>your shopping rewards</u> through
<%Response.Write(NetworkName)%> even more convenient.&nbsp;</font></b>
<p>
<blockquote>
<b><font size=“4”>
<%if browser=“AOL” then
Response.write(“(1) Click the button on the RIGHT HAND side of your mouse on
the ”& NetworkName & “ link below, and choose <i>Add to Favorites. . .</i>
from the pop-up menu.<p><blockquote>”)
End if
%>
<%if browser=“IE” then
Response.write(“(1) Drag the “& NetworkName & ” link below to your Link menu
bar.<p><blockquote>”)
Response.write(“<i>(to make the Link menu bar show on your IE browser, use
the menu item View:Toolbars and put a check by Links.)<i>”)
End if
%>
<%if browser=“Netscape” then
Response.write(“(1) Drag the “& NetworkName & ” link below to your Personal
Toolbar.<p><blockquote>”)
Response.write(“<i>(to make the Personal Toolbar show on your Netscape
browser, click the lever at the extreme left near the top of your
browser.) (</i>”)
End if
%>
<%if browser=“other” then
Response.write(“(1) Save this link below as a bookmark <p>”)
End if
%>
</b></font>
<blockquote>
  <blockquote>
<p>
<br>
  <b>
  <font size=“5”>
<center>
<%if sn_id=“110” then sn_id=“271828” End if%>
  <a
href=“javascript:self.location=&quot;http://www.geniepoint.com/geniepoint/gp
redir.asp?sid=<%
Response.Write(sn_id)%>&amp;aid=<%Response.Write(acct_id)%>&amp;gpid=<%Respo
nse.Write(gpid)%>&amp;frompage=&quot;+escape(document.URL);void(0);”><%Respo
nse.Write(NetworkName)%>
<% Response.Write(nickname)%></a>
</center>
    &nbsp;</font></b>
</p>
  </blockquote>
</blockquote>
<b><font size=“4”>
<%if browser=“AOL”then
Response.write(“</blockquote><p>(2) Then, when shopping at a website, just
click on the Favorites (purple) section of your AOL toolbar, find this link
in the drop-down list and click it!&nbsp;”)
End if
%>
<%if browser=“IE” then
Response.write(“</blockquote><p>(2) Then, when shopping at a website, just
click that link button!&nbsp;”)
End if
%>
<%if browser=“Netscape”then
Response.write(“</blockquote><p>(2) Then, when shopping at a website, just
click that link button!&nbsp;”)
End if
%>
<%if browser=“other” then
Response.write(“<p>(2) Then, when shopping at a website, just click that
bookmark!&nbsp;<p>”)
End if
%>
<p>
</blockquote>
<b><font size=“4”>
<center>
<blockquote>
<blockquote>
<blockquote>
<hr>
It will check the shopping site and automatically route you through your
Shopping Network, so your shopping purchases count towards your
rewards!&nbsp;
<hr>
</blockquote>
</blockquote>
</blockquote>
</center>
</font></b>
<p>&nbsp;</p>
<p>&nbsp;</p>
<p>
</p>
</body></html>
```

Table 2 shows an exemplary implementation in Active Server Pages of Agent Website 12 page to construct a response for the user. It's name is gpredir.asp, and its full address is http://www.geniepoint.com/geniepoint/gpredir.asp.

TABLE 2
Exemplary ASP code for
Agent website

```
<%Response.Buffer =true%>
<html>
<head>
<title>Geniepoint!</title>
</head>
<body>
<%set sn_id = Request.QueryString(“sid”)%>
<%set acct_id = Request.QueryString(“aid”)%>
<%set from_page = Request.QueryString(“frompage”)%>
<%set gpu_id = Request.QueryString(“gpid”)%>
<%
orig_from_page = from_page
from_page= from_page & “/”
embed=right(from_page,len(from_page) −4)
pos1=InStr(embed,“http”)
if pos1>0 then
  from_page=right(embed,len(embed) −pos1+1)
end if
pos1=InStr(from_page, “//”)+1
tail=right(from_page,len(from_page) −pos1)
pos2=InStr(tail,“/”)
stem=left(from_page,pos1+pos2)
from_page=“#” & stem & “#”
%>
<%Set MyConnection = Server.CreateObject(“ADODB.Connection”)%>
<%MyConnection.Open “Provider=Microsoft.Jet.OLEDB.4.0;Data
Source=d:\inetpub\065\_private\Data\genie.mdb”%>
<%Query0 = “SELECT * FROM ShoppingNetwork WHERE ShoppingNetworkID = ” &
sn_id & “ ” %>
<%Set List0 = MyConnection.Execute(Query0)%>
<%
pcolor=black
If Not List0.EOF then
  pcolor=List0(“PrimaryColor”)
  tcolor=List0(“ColorText”)
  lcolor=List0(“ColorLink”)
  mccolor=List0(“ColorMainCell”)
  scolor=List0(“SecondaryColor”)
End if
%>
<style fprolloverstyle>A:hover{color: <%=pcolor%>}</style>
</head>
<% If List0.EOF then
  Response.Write(“Shopping Network code unknown”)
  Response.Write(“Hit Back Button to return to your page”)
End if%>
<body bgcolor=“<%=pcolor%>“ text=”<%=tcolor%>” ’
  link=“<%=lcolor%>“ vlink=”<%=lcolor%>”
  alink=“#FF0000”>
<div align=“center”>
  <center>
<table border=“0” width=“636” bgcolor=“<%=mccolor%>”>
  <tr>
  <td width=“160” bgcolor=“<%=scolor%>”>
    <table border=“0” width=“100%” cellspacing=“1”>
      <tr>
        <td width=“100%”><IMG
src=“http://www.geniepoint.com/geniepoint/images/<%response.write(List0(“Sho
ppingNetworkLogo”))%>”></td>
      </tr>
    </table>
    </td>
    <td width=“462” colspan=“4”>
    <p align=“center”><i><b><font size=“2”>
    </font></b></i></p>
    </td>
  </tr>
  <tr>
    <td width=“622” colspan=“5” align=“center”><font face=“Verdana”
size=“3”>
    <hr>
<% If Not List0.EOF then %>
<%
set NetworkName =List0(“ShoppingNetworkName”)
set ContactName =List0(“ShoppingNetworkContact”)
    if sn_id=“110” then
        mallURL = “http://www.scholarshops.com/mall.asp?sid=” & acct_id&
“&source=GeniePointRedir”
    End if
    if sn_id=“120” then
        mallURL = “http://www.mikedoherty.com/SeniorTowne/shop.htm”
    End if%>
<%Query1 = “SELECT * FROM snMerchantCodes WHERE( snID = “ & sn_id & ” AND
snURL= ‘ “& from_page & ” ’)” %>
<%Set List1 = MyConnection.Execute(Query1)%>
<%
    If Not List1.EOF then
```

set merchantname = List1(“gpMerchantName”)
set mto=List1(“gpMerchantID”)
set mfrom=List1(“gpMerchantID”)
if sn_id=“110” then

targetURL = “http://www.scholarshops.com/nav2.asp?sid ” & acct_id

& “&mid=” & List1(“snMerchantID”)& “&source=GeniePointSave”

End if
if sn_id=“120” then
targetURL = “http://www.mikedoherty.com/SeniorTowne/shop.htm”
End if
targetURL=replace(targetURL, “&”, “$”)
valetURL=

“http://www.geniepoint.com/geniepoint/gpvalet.asp?tt=M&gpuid=” &gpu_id&
“&sid=”&sn_id&“&aid=” & acct_id & “&mtid” & mto & “&mfid=” & mfrom &
“&mturl=”&targetURL

Response.Write(targetURL)
Response.Write(“<hr>”)
Response.Write(valetURL)
if sn_id=“110” then Response.Redirect valetURL End if
if sn_id=“120” then Response.Redirect targetURL End if

```
  End if
%>
<%
  If List1.EOF then
```

Query2 = “SELECT * FROM ProductionSubstitution WHERE( snID = ” & sn_id

& “ AND goURL= ‘ “& from_page & ” ’) ORDER BY MaxOfstrength DESC”

Set List2 =MyConnection.Execute(Query2)
If List2.EOF then %>

<p><b><font size=“4” color=“#000000”>
<%Response.Write(“. . .Sorry, the previous website is not an

affiliate of <i>”)%>

<font size=“5” color=“<%=tcolor%>”>
<%Response.Write( NetworkName) %>
</font>
<%Response.Write(“<i><p>You may shop by going to. . .”)%>
<%targetURL=replace(mallURL,“&”, “$”)
midcode=0
valetURL=

“http://www.geniepoint.com/geniepoint/gpvalet.asp?tt=X&gpuid=” &gpu_id&
“&sid=” &sn_id& “&aid=” &acct_id& “&mtid=” & midcode & “&mfid=” & midcode &
“&mturl=”&targetURL

%>
<p><b><font size=“5”

color=“#800080”>&nbsp;&nbsp;&nbsp;&nbsp;&nbsp;&nbsp;&nbsp;

<a href=“<%Response.Write(valetURL)%>”>
<%Response.Write(NetworkName)%>
</font></a></b>
<p><b><font size=“4” color=“#000000”>
<%Response.Write(“<br>or return to your”) %>
</font></a></b>
<b><font size=“4” color=“#800080”>&nbsp;&nbsp;
<a href=“<%Response.write(orig_from_page) %>”>
<%Response.Write(“Previous Page”)%>
</font></a></b>

<%End if
If Not List2.EOF then %>

<p><b><font size=“4”color=“#000000”>
<%Response.Write(“. . .Sorry, <i>” & List2(“Mfrom”) & “</i> is not

an affiliate of <i>”)%>

<font size=“5” color=“<%=tcolor%>”>
<%Response.Write( NetworkName) %>
</font>
<%Response.Write(“</i>.<br><p>But you may find similar shopping at

these alternate merchants, which <u>are</u> affiliates:”)%>

</font></a></b>
<div align=“center”>
<center>
<table border=“0” width=“100%”>
<b>
<tr>
<td></b>
<%do until List2.EOF %>

<%
similarity=List2(“MaxOfstrength”)
if similarity > 100 then

simcode=“>>”
myfont=4

End if
if similarity <= 100 then

simcode=“ >”
myfont= 3

End if
simcode=“ ”
if sn_id=“110” then

targetURL = “http://www.scholarshops.com/nav2.asp?sid=” &

acct_id & “&mid=” & List2(“snMerchantID”) & “&source=GeniePointRedir”

End if
if sn_id=“120” then
targetURL =

“http://www.mikedoherty.com/SeniorTowne/shop.htm”

End if
%>
<%targetURL=replace(targetURL,“&”,“$”)
mfrom=List2(“gpMIDfrom”)
mto=List2(“gpMIDto”)
valetURL=

“http://www.geniepoint.com/geniepoint/gpvalet.asp?tt=R&gpuid=” &gpu_id&
“&sid=”&sn_id&“&aid=” & acct_id & “&mtid=” & mto & “&mfid=” & mfrom &
“&mturl=”&targetURL

%>

<tr>

<td width=“35%”

align=right><b><%Response.Write(simcode)%></b></td>

<td width=“50%”><font size=“<%=myfont%>” color=“#800080”><b>
<a href=<%Response.Write(valetURL)%>>
<%=List2(“Mto”)%></a></b></font></td>
<td width=“15%”>&nbsp;</td>

</tr>
<%List2.MoveNext
loop%>
</table>
</center>
</div>
<p><b><font size=“4” color=“#000000”>
<%Response.Write(“<hr>. . .or return to your”) %>
</font></a></b>
<b><font size=“4” color=“#800080”>&nbsp;&nbsp;&nbsp;
<a href=“<%Response.Write(orig_from_page)%>”>
<%Response.Write(“Previous Page”)%>
</font></a></b>
<% MyConnection.Close %>
<%End if

```
    End if %>
<%End if%>
</td>
  </tr>
  <tr>
```

```
<td width=“160”>&nbsp;</td>
<td width=“116”>&nbsp;</td>
<td width=“115”>&nbsp;</td>
<td width=“109”>&nbsp;</td>
<td width=“104”>
  <p align=“center”><font face=“Verdana” size=“1”>
  <a href=“http://www.geniepoint.com/geniepoint/about.htm”>
```

<IMG border=0

src=“http: //www.geniepoint.com/geniepoint/images/Genie_Point_powered_by.gif”
>

</a></font></p>

</td>

```
  </tr>
</table>
  </center>
</div>
</body>
</html>
```

The code in Table 2 may present the user a page such as that shown in FIG. 4, in which the user has alternative options to click. The enterprise may desire to record what the user's choice was, and so the links presented by the example code above point not directly to the destinations described by their text labels, but to another web page in the Agent Website, discussed next.

Table 3 shows an exemplary implementation in Active Server Pages of the Agent Website 12 process for managing the response to the user. It is termed a “valet” because it manages implementing the choice made by the user, and also tracks in Database 22 what that choice was, when it was made, and personalization data associated with the user. It's name is gpvalet.asp, and its full address is http://www.geniepoint.com/geniepoint/gpvalet.asp.

TABLE 3
Exemplary ASP code for
Agent Website valet process

<%Response.Buffer = true%>
<html>
<head>
<meta http-equiv=“Content-Language” content=“en-us”>
<meta http-equiv=“Content-Type” content=“text/html;
charset=windows-1252”>
<meta name=“GENERATOR” content=“Microsoft FrontPage 4.0”>
<meta name=“ProgId” content=“FrontPage.Editor.Document”>
<title>GeniePoint!</title>
</head>
GeniePoint valet - ready to insert<br>
<%set sn_id = Request.QueryString(“sid”)%>
<%set acct_id = Request.QueryString(“aid”)%>
<%set mfrom_id = Request.QueryString(“mfid”)%>
<%set gpuser_id = Request.QueryString(“gpuid”)%>
<%set transtype = Request.QueryString(“tt”)%>
<%set mto_id = Request.QueryString(“mtid”)%>
<%set mto_url = Request.QueryString(“mturl”)%>
<%
mto_url=replace(mto_url,“$”,“&”)
transtype=““““&transtype&””””
%>
<%datestamp = now()%>
Response.Write(datestamp &“<br>”)
Response.Write(transtype &“<br>”)
Response.Write(gpuser_id & “<br>”)
Response.Write(sn_id &“<br>”)
Response.Write(acct_id &“<br>”)
Response.Write(mfrom_id &“<br>”)
Response.Write(mto_id &“<br>”)
Response.Write(mto_url &“<br>”)
%>
<%Const adOpenDynamic = 3, adLockOptomistic = 3%>
<%Set MyConnection = Server.CreateObject(“ADODB.Connection”)%>
<%MyConnection.Open “Provider=Microsoft.Jet.OLEDB.4.0;Data
Source=d:\inetpub\065\_private\Data\Data2\gptracking.mdb”%>
<%Query0 = “INSERT INTO activity
(date_time,transtype,gpuser_id,acct_id,sn_id,mto_id,Mfrom_id)
VALUES (“““ & datestamp & ”””,“ & transtype & ”,“ & gpuser id &”,“
& acct_id &”,“ & sn_id &”,“ & mto_id &”,“ & mfrom_Id &”) ”%>
<%Response.write(“<hr>”&Query0)%>
<%MyConnection.Execute(Query0)%>
done.
Response.Redirect(mto_url)
</body></html>%>

An exemplary e-mail message consistent with Example 4 and the GeniePoint web pages shown in Tables 1, 2, and 3 above, is shown in Table 4.

TABLE 4
Exemplary e-mail Message
Inviting User to the Agent Link Generation website

Hello, Uncle Frank . . .

As you know, I away here at college, studying hard to become successful like you! And
books are so expensive, I frequently find myself short of cash. So, I've registered with an
internet shopping mall called ScholarShops! And I get paid a rebate whenever someone
shops at a merchant affiliated with them-but it only works if my account code is in the
shopping link. It's sort of like designating me to get your “green stamps” when you shop.
If you just follow this link, it will explain more . . . and help me out! --And remember, it doesn't
mean you pay more, it's just that I'll get a rebate!
http://www.geniepoint.com/geniepoint/gplinkgen.asp?sid=110&aid=101

Your Favorite Nephew,

Joe (Black)

The link in the e-mail message in Table 4 contains two pieces of personalization data:

sid=110 specifies the shopping network identification code; 110 refers to Scholarshops, a network where Joe Black is registered.

aid=101 is an account identification code; among ScholarShops accounts, 101 refers to Joe Black.

The link in the e-mail message may have been created by ScholarShops and e-mailed to Joe Black, who then incorporated it into customized messages to many of his relatives, such as Uncle Frank. Or the link may have been created by the enterprise which created GeniePoint and sent to Scholarshops, as well as to other Shopping Networks who use the GeniePoint capability.

Hardware Environment

The invention works on a network with connected clients and servers. The clients are typically personal computers, through which the user browses content stored on servers or other clients. In FIG. 1 computer 53 is the client, and computers 51 and 52 are servers, and all of them are connected to network 30. The servers are computers which respond to requests received over the network, replying by returning information to the requester. Websites 14 of FIG. 1 are examples of content on servers connected to the network. A large network has many clients and servers connected to it. These connections may be made using wires or optical fibers or wireless signal transmissions.

Computers 51 and 52 may be the same computer, and databases 20 and 22 may be the same database. It is also possible for Agent Link Creation Website 10 to access and use database 22, and for Agent Website 12 to access and use database 20. One ordinarily skilled in the art of databases and networks could implement those permissions, including any appropriate security measures, if desired.

Computers 51, 52, and 53 may also be implemented by devices such as portable computers, hand-held computers, laptop computers, personal information managers, or cell phones, or other electronic devices, which have a memory, a processor, a network connection device, user input device, display device, and software and/or firmware to provide a network browser.

### Benefits

The benefits of the invention include the following.

1. The Agent Link saves the user time and trouble and eliminates errors in typing. The functionality of the Agent Website could be provided without the Agent Link, but the user would have to enter the URL of the page browsed, and (a) the user would have to provide the personalization data by entering it each time or (b) a cookie (small persistent file on the user's browsing device) would have to be used to store the personalization data. If a cookie is used then the Agent Link does not totally encapsulate the personalization data, and it can't be e-mailed to others and maintain all the data

2. The user can easily have multiple Agent Links, each representing a particular set of personalization data. The links can be custom named to represent the data

3. The Agent Links can be saved in any browser that permits links with scripting.

4. Users can share their Agent Link with others by e-mailing the URL or by directing them to the Agent Link Creation Website via a link that already has the personalization data specified in the query string.

5. The user has total control of whether or not to invoke the agent.

6. The enterprise that designs and implements the Agent Website and the Agent Link Creation Website has the great opportunity to intervene in the user's web browsing (when permitted by the user clicking the Agent Link). This intervening may be used to influence the user, deliver commercial or political messages, redirect the user to other sites, or to gather additional data on the spot from the user. The enterprise that designs and implements the Agent Website and the Agent Link Creation Website can gather data about users' web browsing (what pages are visited, and when they are visited) and have this data associated with the personalization information from the Agent Link. This can be used for market research.

What is claimed is:

1. A method of assisting a person navigating locations on a hyperlinked network, the method comprising:
(a) constructing a computer program with means for determining the address on said hyperlinked network of a location addressed by a browser;
(b) obtaining data about said person;
(c) constructing an Agent Link comprised of an Agent Website address on said hyperlinked network, said data, and said computer program;
(d) construction of an Agent Website at said Agent Website address, with means for extracting the information carried in the link referencing it, analyzing said information, and presenting said person a response.
(e) presenting said person said Agent Link and instructions to save it and use it later;

2. The method of claim 1, wherein said response is automatic redirection of said person to another network location.

3. The method of claim 1, wherein said response is automatic return of said person to the same network location, but with additional information communicated to said same network location.

4. The method of claim 1, wherein said response is a message and a plurality of links to network locations.

5. The method of claim 1 wherein said response is an inquiry of said user and a means to record and save inputs from said user.
